(19) United States
(12) Patent Application Publication
(10) Pub. No.: US 2009/0301263 A1
(43) Pub. Date: Dec. 10, 2009

(54) Self-adjustable universal ratchet spanner

(76) Inventor: Kwang-Moo Kim, Seoul (KR)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/385,481

(22) Filed: Apr. 9, 2009

(30) Foreign Application Priority Data
Jun. 4, 2008 (KR) 10-2008-0052381

(51) Int. Cl. B25B 13/46; B25B 13/12

(52) U.S. Cl. 81/58.2; 81/179

(57) ABSTRACT

Provided is a self-adjustable universal ratchet spanner enabling simple and continuous tightening or releasing of various sizes of hex head bolts or nuts by repeatedly pivoting the ratchet spanner in a state in which a spanner head is engaged with hex heads of the bolts or nuts, without separation of the spanner head from the heads of the bolts or nuts. The self-adjustable universal ratchet spanner includes a spanner head having a lower jaw integrally formed with the spanner head, and an upper jaw disposed at a rear part of the spanner head and resiliently supported by a spring, wherein the upper and lower jaws are engaged with hex head bolts or nuts so that the upper jaw resiliently supported by the spring moves forward and backward depending on variable diameter between flat surfaces of the hex head bolts and vertexes upon rotation thereof to tighten or release the hex head bolts or nuts, thereby performing a ratchet function of the spanner.

### CROSS-REFERENCE TO RELATED APPLICATION

This application claims the benefit of Korean Patent Application No. 2008-0052381, filed Jun. 4, 2008, the disclosure of which is hereby incorporated herein by reference in its entirety.

### BACKGROUND OF THE INVENTION

1. Field of the invention

The present invention relates to a self-adjustable universal ratchet spanner, and more particularly, to a self-adjustable universal ratchet spanner enabling simple and continuous tightening or releasing of various sizes of hex head bolts or nuts by repeatedly pivoting the ratchet spanner in a state in which a spanner head is engaged with hex heads of the bolts or nuts, without separation of the spanner head from the heads of the bolts or nuts.

In particular, the present invention relates to a self-adjustable universal ratchet spanner capable of simplifying a complex structure and reducing the number of components to reduce manufacturing cost, in connection with Korean Patent Registration No. 10-0567377 (U.S. Pat. No. 6,945,143) and Korean Patent Registration No. 10-0744049 (U.S. Pat. No. 7,228,768), which are filed by the applicant of the present invention.

2. Description of the Prior Art

In a conventional spanner, a handle thereof is configured to be rotated in one direction in order to tighten or release hex head bolts or nuts. However, whenever the bolts or nuts are rotated by the spanner, a spanner head engaged with the hex head of the bolts or nuts must be separated from the hex head and then engaged therewith again to rotate the bolts or nuts in repeatedly, thereby causing inconvenience in use. In addition, since a bolt insertion groove of the spanner head has a fixed size designated to the bolt head or nut, various sizes of spanners corresponding to the bolt heads or nuts must be separately prepared to cause use inconvenience of the spanners. Further, when various sizes of bolts and nuts are to be tightened or released in the same place, spanners having sizes corresponding to the bolt and nuts must be changed and used. As a result, preparation and exchange use of the various sizes of spanners cause inconvenience and troublesome operations.

Furthermore, while a spanner having an adjustable size depending on the size of bolt heads or nuts, called a monkey spanner, may be provided to be used regardless of the sizes of the bolt heads or nuts, the monkey spanner also has some of the same disadvantages of troublesome and inconvenient operations as the conventional spanners including repeated separation and engagement between the spanner head and the bolt heads or nuts at each operation. Moreover, a gap between a stationary jaw and a movable jaw of the spanner for tightening or releasing the bolt heads or nuts may be readily varied to cause frequent re-adjustment of the gap.

In order to solve these problems, a ratchet spanner has been developed and widely used to tighten or release hex head bolts or nuts through repeated pivotal movements. However, the ratchet spanner includes a ratchet gear and other complex elements assembled to each other. This increases manufacturing cost, thereby imposing an economic burden on users. In addition, due to abnormal operation in use or structural weakness of the ratchet spanner, the ratchet spanner is easily broken. Further, since the ratchet spanner includes sockets having fixed sizes engaged with the hex head bolts or nuts, the sockets must be exchanged depending on the sizes of the hex head bolts or nuts. Furthermore, since the sockets separated from the spanner are likely to be lost, a user must be careful with the sockets. When a bolt having a crushed head is used, the socket of the spanner cannot be fitted onto the bolt head. Hence, it is difficult to use the socket with crushed bolt heads or nuts.

In order to solve the various problems related to the conventional spanners, Korean Patent Registration No. 10-0567377 (U.S. Pat. No. 6,945,143) and Korean Patent Registration No. 10-0744049 (U.S. Pat. No. 7,228,768), which are filed by the applicant, disclose self-adjustable universal ratchet spanners enabling simple and continuous tightening or releasing of various sizes of hex head bolts or nuts by repeatedly pivoting the ratchet spanner in a state in which a spanner head is engaged with hex heads of the bolts or nuts, without separation of the spanner head from the heads of the bolts or nuts.

However, in the case of the spanner disclosed in Korean Patent Registration No. 10-0567377 (U.S. Pat. No. 6,945,143), a slide groove is formed in an upper jaw of a spanner head, and a trapezoidal member is inserted into and slid along the slide groove, complicating a structure of the spanner. As a result, manufacture of the spanner is difficult and the spanner head is too large for smooth operation.

In addition, in the case of the spanner disclosed in Korean Patent Registration No. 10-0744049 (U.S. Pat. No. 7,228,768), subsidiary elements for smoothly operating an upper jaw and preventing the upper jaw from being pushed backward to perform ratchet operation are complicated, making it difficult to manufacture the spanner. Further, a structure for inserting various sizes of bolt heads or nuts employs a front insertion type, thus complicating the structure and increasing manufacturing cost thereof.

### SUMMARY OF THE INVENTION

An object of the present invention is to provide a self-adjustable universal ratchet spanner capable of solving the problems of the conventional spanners and ratchet spanners and improving disadvantages and inconvenience of the previous patents of the applicant to simply apply a single spanner to various sizes of bolts heads and nuts having a small difference.

Another object of the present invention is to provide a self-adjustable universal ratchet spanner enabling tightening or releasing of hex head bolts or nuts by rotating the bolts or nuts in one direction through simple and repeated pivotal movements, in a state in which the spanner is engaged with the bolts or nuts, without repeated engagements and disengagements with/from the bolt heads or nuts whenever the spanner is pivoted.

Still another object of the present invention is to provide a self-adjustable universal ratchet spanner in which an upper jaw of the spanner resiliently supported by a spring moves forward and backward when the spanner head moves to an engagement position upon tightening or release of the bolts heads or nuts to absorb a rotation gap according to the diameter of the hex head, and the upper and lower jaws are seated on flat surfaces of the hex head bolts or nuts to tighten or release the bolts or nuts upon their engagement, thereby preventing slippage or skidding of the upper jaw and improving operation efficiency through secure tightening or release of the bolts or nuts.

Yet another object of the present invention is to provide a self-adjustable universal ratchet spanner including an upper jaw that can be separated from the spanner head to move forward and backward and a lower jaw fixed to the spanner head, thereby simplifying a structure of the spanner in comparison with the conventional spanners to enable easy assembly and reducing the number of components to enable mass production at a low cost.

Yet another object of the present invention is to provide a self-adjustable universal ratchet spanner in which a structure of the spanner is simplified to reduce probability of malfunction, assembly and manufacture can be readily performed, and a gap between jaws is automatically corrected to various sizes of bolt heads or nuts to provide a large number of ratchet spanners at a low price, so that the ratchet spanners can be economically and conveniently used in industrial sites or at home.

An aspect of the invention provides a self-adjustable universal ratchet spanner including: a spanner head having a lower jaw integrally formed with the spanner head, and an upper jaw disposed at a rear part of the spanner head and resiliently supported by a spring, wherein the upper and lower jaws are engaged with hex head bolts or nuts so that the upper jaw resiliently supported by the spring moves forward and backward depending on variable diameter between flat surfaces of the hex head bolts and vertexes upon rotation thereof to tighten or release the hex head bolts or nuts, thereby performing a ratchet function of the spanner.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view of a self-adjustable universal ratchet spanner in accordance with an exemplary embodiment of the present invention;

FIGS. 2A to 2D are front views showing operation states of the ratchet spanner according to steps of a bolt tightening process;

FIG. 3 is a front view of a released operation state of the bolt;

FIG. 4 is an exploded perspective view of a self-adjustable universal ratchet spanner in accordance with a second exemplary embodiment of the present invention;

FIG. 5 is a view of the ratchet spanner of the second embodiment applied to a small bolt or nut; and

FIG. 6 is a view of the ratchet spanner of the second embodiment applied to a large bolt or nut.

### DETAILED DESCRIPTION OF EXEMPLARY EMBODIMENTS

Hereinafter, exemplary embodiments of the present invention will be described with reference to the accompanying drawings.

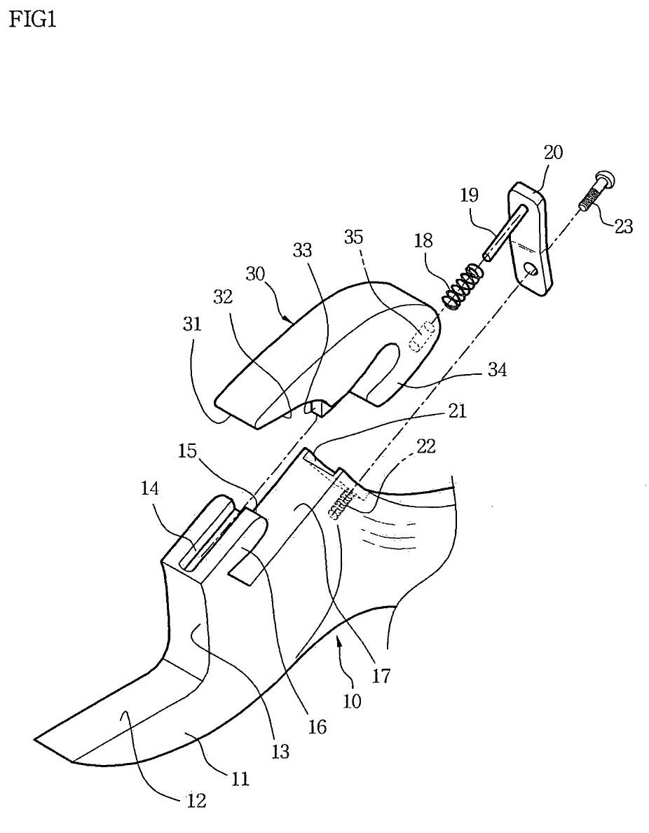

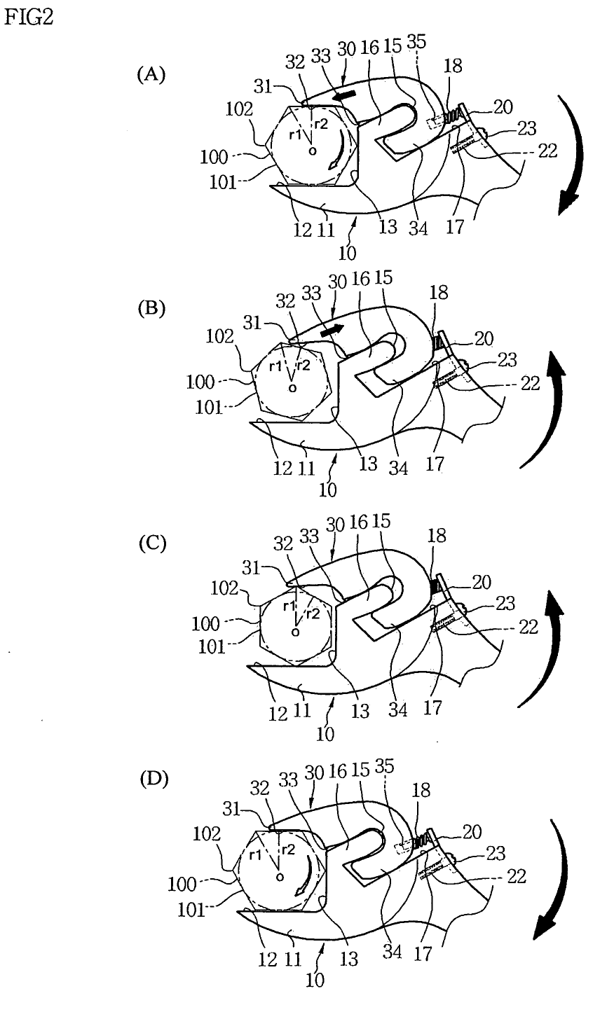

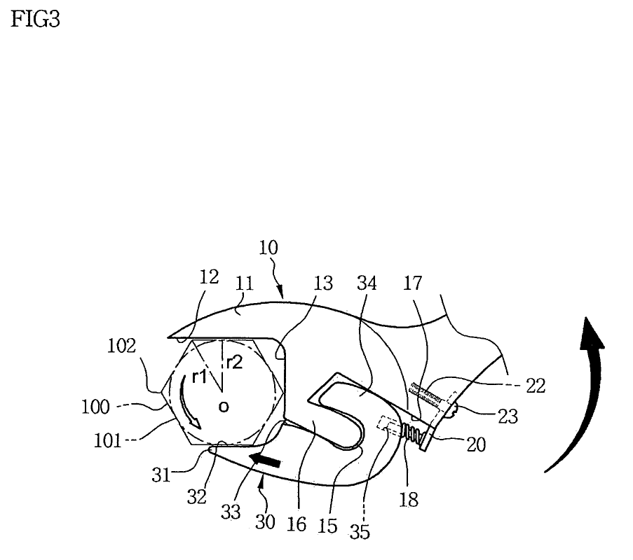

FIG. 1 is an exploded perspective view of a self-adjustable universal ratchet spanner in accordance with an exemplary embodiment of the present invention, FIGS. 2A to 2D are front views showing operation states of the ratchet spanner according to steps of a bolt tightening process, and FIG. 3 is a front view of a released operation state of the bolt.

As shown in FIGS. 1 to 3, a self-adjustable universal ratchet spanner in accordance with an exemplary embodiment of the present invention includes a spanner head 10 having a lower jaw 11 integrally formed therewith, and a movable upper jaw 30.

The spanner head 10 has the lower jaw 11 with an engagement surface 12 evenly and elongatedly formed to be in contact with flat surfaces 101 of a hex head 100 of a bolt or nut. A slide fixing groove 14 is formed in an upper part of a rear vertical surface 13 of the engagement surface 12 and opened at only its rear side. A fixing projection 16 projects from the lower jaw in an upwardly inclined direction to form a round end surface 15. A slide guide surface 17 is formed under the fixing projection 16 in an upwardly inclined direction, and a fixing piece 20 having a fixing pin 19 installed at its one side and a spring 18 installed around the fixing pin 19 is inserted into an insertion groove 21 and fastened to a rear upper part of the slide guide surface 17 by a bolt 23 threadedly engaged with a threaded hole 22 formed in a rear part of the spanner head 10.

The upper jaw 30 has a rounded end surface 31, an engagement surface 32 evenly and elongatedly formed to be in contact with the flat surface 31 of the hex head 100 of a bolt or nut, an anti-separation threshold 33 formed at a rear part of the engagement surface 32, a coupling projection 34 formed at a rear end of the anti-separation threshold 33 and having a substantially circular profile, and a fixing pin insertion hole 35 formed at a rear end of the coupling projection 34.

Therefore, when the upper jaw 30 is assembled to the spanner head 10, the anti-separation threshold 33 of the upper jaw 30 is inserted into the slide fixing groove 14 of the spanner head 10 to prevent the upper jaw 30 from being separated from the groove 14 in lateral and forward directions. In addition, the coupling projection 34 of the upper jaw 30, which has a substantially arcuate profile, is engaged with the fixing projection 16 of the spanner head 10 to surround the fixing projection 16. The upper jaw 30 is resiliently installed by the fixing pin 19 formed at the fixing piece 20 and the spring 18 inserted into the fixing pin insertion hole 35 formed at a rear end of the upper jaw 30 so that the upper jaw 30 is securely and stably assembled to the spanner head 10.

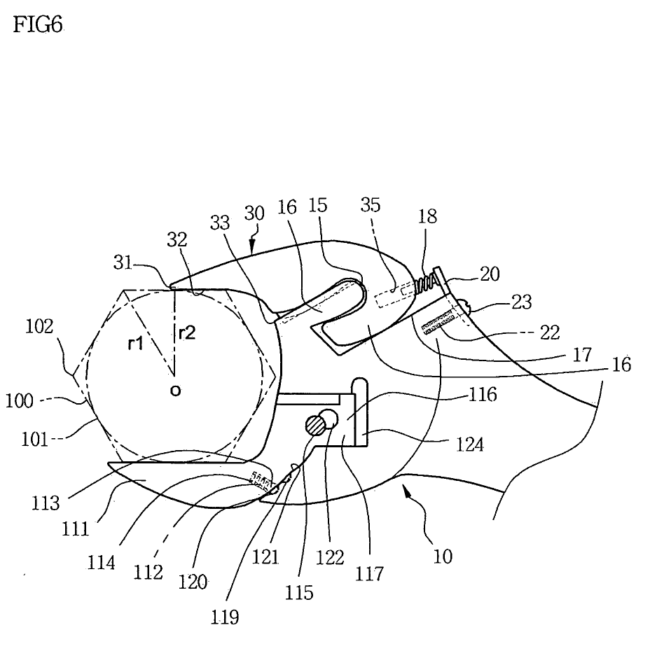

As shown in FIGS. 2A to 2D and 6, after the spanner head 10 is slid toward the flat surfaces 101 of a hex head 100 of a bolt or nut so that the hex head 100 is inserted between the engagement surfaces 12 and 32 of the lower and upper jaws 11 and 30 (see FIG. 2A), when the spanner head 10 is rotated clockwise, the hex head 100 of the bolt or nut is rotated clockwise to be tightened. At this time, the flat surfaces 101 of the hex head 100 of the bolt or nut are in contact with the engagement surfaces 12 and 32 of the lower and upper jaws 11 and 30 at large areas in a symmetrical manner so that a large force is applied to apply a large pressure to the upper jaw 30 in a direction opposite to the rotation direction. Here, since the coupling projection 34 of the upper jaw 30 having a substantially arcuate profile is engaged with the fixing projection 16 of the spanner head 10 to surround the fixing projection 16, the hex head 100 of the bolt or nut can be rotated clockwise to be tightened, without backward movement of the upper jaw 30 (see FIG. 2A). Then, when the spanner head 10 is rotated counterclockwise, a rotational force applied to the hex head 100, the lower jaw 11 and the upper jaw 30 caused by the rotation of the spanner head 10 is applied in an opposite direction to move the upper jaw resiliently supported by the spring 19 backward. When the engagement surface of the upper jaw 30 is in contact with a radius r1 of a vertex 102, not a radius r2 of the flat surface 101 of the hex head 100, the upper jaw 30 is pushed backward by a difference between the radii r2 and r1 due to rotational reaction caused by variation in distance thereof. At this time, since the anti-separation threshold 33 of the upper jaw 30 is inserted into the slide fixing groove 14 of the spanner head 10, it is possible to prevent lateral or forward separation of the upper jaw 30. In addition, since the coupling projection 34 of the upper jaw 30 having a substantially arcuate profile is engaged with the fixing projection 16 of the spanner head 10, the upper jaw 30 is moved backward by the fixing pin 19 and the spring 18 to a difference between the radii r2 and r1, and the lower and upper jaws 11 and 30 of the spanner head 10 pass the vertex 102 to be adhered to the flat surfaces 101 by the spring 18 (see FIGS. 2B to 2D). These operations are repeated to tighten the hex head 100 of the bolt or nut, without separation of the spanner head 10 from the hex head 100.

Further, when the bolt or nut is to be rotated in an opposite direction, as shown in FIG. 3, the spanner head 10 is reversed to 180° to be rotated as above to release the bolt or nut.

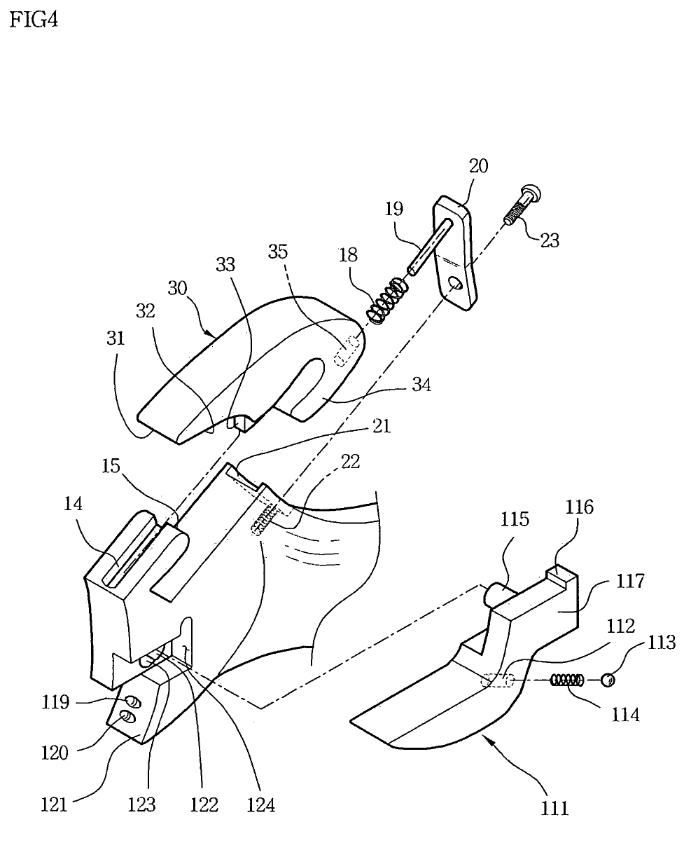

Meanwhile, FIGS. 4 to 6 show a second embodiment of the present invention. While the first embodiment has been described in that the lower jaw 11 is integrally formed with the spanner head 10, in the second embodiment, the lower jaw 11 is separated from the spanner head 10 to be applied to a wider size range of the bolt or nut through two-stage adjustment.

As shown in FIGS. 4 to 6, an upper jaw 30 has the same constitution as in the first embodiment.

A lower jaw 111 of the second embodiment is separated from a spanner head 10. An insertion hole 112 is formed in a lower rear end of the lower jaw 111, and a fastening ball 113 is inserted and resiliently supported by a spring 114. A fixing piece 117 is formed at a rear part of the lower jaw 111 and has a fixing pin 115 and a fixing threshold 16 formed at a rear inner surface and a rear end thereof.

The spanner head 10, to which the lower jaw 111 is coupled, has an arcuate engagement part 121 having fastening holes 119 and 120 formed at upper and lower sides thereof. An insertion groove 124 is formed in an upper inner side of the spanner head 10 and has gap adjustment holes 122 and 123 continuously formed therein. The fixing piece 117 formed at a rear part of the lower jaw 111 and having a fixing pin 115 and a fixing threshold 116 is inserted into the insertion groove 124.

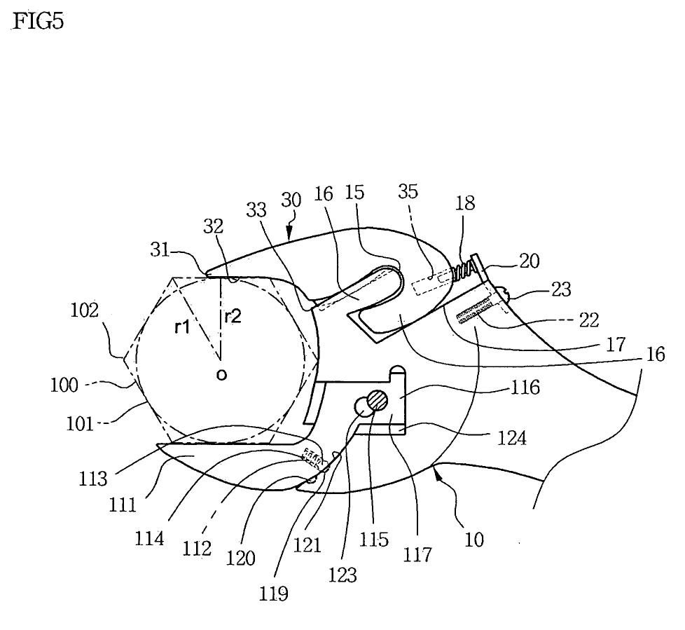

Therefore, as shown in FIG. 5, when the fixing pin 115 formed in the rear inner side of the lower jaw 111 is inserted into the gap adjustment hole 122 and the fastening ball 113 of the lower jaw 111 is inserted into the fastening hole 119, the spanner head 10 can be applied to a smaller size of hex head bolts or nuts. As shown in FIG. 6, when the fixing pin 115 formed in the rear inner side of the lower jaw 111 is inserted into the gap adjustment hole 123 and the fastening ball 113 of the lower jaw 111 is inserted into the fastening hole 120, the spanner head 10 can be applied to a larger size of hex head bolts or nuts that that of FIG. 5. Even in this case, the upper jaw 30 is operated as described in FIGS. 2 and 3 to enlarge the sizes of the bolts or nuts, as can be readily appreciated by those skilled in the art.

As can be seen from the foregoing, a self-adjustable universal ratchet spanner can solve the problems of the conventional spanners and ratchet spanners and improve disadvantages and inconvenience of the previous patents of the applicant to simply apply a single spanner to various sizes of bolt heads and nuts having a small difference. In addition, the self-adjustable universal ratchet spanner enables hex head bolts or nuts to be tightened or released by rotating the bolts or nuts in one direction through simple and repeated pivotal movements, in a state in which the spanner is engaged with the bolts or nuts, without repeated engagements and disengagements with/from the bolt heads or nuts whenever the spanner is pivoted. Further, in the self-adjustable universal ratchet spanner, an upper jaw of the spanner resiliently supported by a spring moves forward and backward when the spanner head moves to an engagement position upon tightening or release of the bolt heads or nuts to absorb a rotation gap according to the diameter of the hex head, and the upper and lower jaws are seated on flat surfaces of the hex head bolts or nuts to tighten or release the bolts or nuts upon their engagement, thereby preventing slippage or skidding of the upper jaw and improving operation efficiency through secure tightening or release of the bolts or nuts.

Furthermore, the self-adjustable universal ratchet spanner includes an upper jaw that can be separated from the spanner head to move forward and backward and a lower jaw fixed to the spanner head, thereby simplifying a structure of the spanner in comparison with the conventional spanners to enable easy assembly and reducing the number of components to enable mass production at a low cost. In addition, in the self-adjustable universal ratchet spanner, a structure of the spanner is simplified to reduce probability of malfunction, assembly and manufacture of the ratchet spanner can be readily performed, and a gap between jaws is automatically corrected to various sizes of bolt heads or nuts. Thus, a large number of ratchet spanners can be provided at a low price, so that the ratchet spanners can be economically and conveniently used in industrial sites or at home.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

What is claimed is:

1. A self-adjustable universal ratchet spanner comprising:
a spanner head (10) including a lower jaw (11) having an engagement surface (12) evenly and elongatedly formed to contact a flat surface (101) of a hex head (100) of a bolt or nut, a slide fixing groove (14) formed in an upper part of a rear vertical surface (13) of the engagement surface (12) and opened at only its rear side, a fixing projection (16) projecting from the lower jaw in an upwardly inclined direction to form a round end surface (15), a slide guide surface (17) formed under the fixing projection (16) in an upwardly inclined direction, and a fixing piece (20) having a fixing pin (19) installed at its one side and a spring (18) installed around the fixing pin (19), inserted into an insertion groove (21), and fastened to a rear upper part of the slide guide surface (17) by a bolt (23) threadedly engaged with a threaded hole (22) formed in a rear part of the spanner head (10); and
an upper jaw (30) having a rounded end surface (31), an engagement surface (32) evenly and elongatedly formed to contact the flat surface (101) of the hex head (100) of a bolt or nut, an anti-separation threshold (33) formed at a rear part of the engagement surface (32), a coupling projection (34) formed at a rear end of the anti-separation threshold (33) and having a substantially circular profile, and a fixing pin insertion hole (35) formed at a rear end of the coupling projection (34).

2. The self-adjustable universal ratchet spanner according to claim 1, wherein the lower jaw (11) is fixed to the spanner head (10).

3. The self-adjustable universal ratchet spanner according to claim 1, wherein the lower jaw (111) is separately provided and detachable from the spanner head (10).

4. The self-adjustable universal ratchet spanner according to claim 1, wherein the lower jaw (111) is configured to be separated from the spanner head (10), and includes an insertion hole (112) formed at a rear part thereof a fastening ball (113) inserted into the insertion hole (112) and resiliently and retractively supported by a spring (114), and a fixing piece (117) having a fixing pin (115) and a fixing threshold (116) formed at a rear inner side and a rear end thereof; and
the spanner head (10) includes an arcuate engagement part (121) having fastening holes (119) and (120) formed at upper and lower sides thereof, an insertion groove (124) having gap adjustment holes (122) and (123) continuously formed therein, so that the fixing piece (117) having the fixing pin (115) and the fixing threshold (116) formed at the rear inner side and the rear end is inserted into the insertion groove (124) to couple the lower jaw (111) to the spanner head (10).

5. The self-adjustable universal ratchet spanner according to claim 3, wherein the lower jaw (111) is configured to be separated from the spanner head (10), and includes an insertion hole (112) formed at a rear part thereof, a fastening ball (113) inserted into the insertion hole (112) and resiliently and retractively supported by a spring (114), and a fixing piece (117) having a fixing pin (115) and a fixing threshold (116) formed at a rear inner side and a rear end thereof; and
the spanner head (10) includes an arcuate engagement part (121) having fastening holes (119) and (120) formed at upper and lower sides thereof, an insertion groove (124) having gap adjustment holes (122) and (123) continuously formed therein, so that the fixing piece (117) having the fixing pin (115) and the fixing threshold (116) formed at the rear inner side and the rear end is inserted into the insertion groove (124) to couple the lower jaw (111) to the spanner head (10).
